(19) United States
(12) Patent Application Publication
(10) Pub. No.: US 2009/0220289 A1
(43) Pub. Date: Sep. 3, 2009

(54) HIGH SPEED DUPLEX PRINTER

(75) Inventor: Jeffrey D. Marsh, Foristell, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Perfect Systems, LLC, Foristell, MO (US)

(21) Appl. No.: 12/039,296

(22) Filed: Feb. 28, 2008

(51) Int. Cl. G03G 15/00

(52) U.S. Cl. 399/364

(57) ABSTRACT

Apparatus and a method is disclosed for duplex printing of a document or a book block in which two printers operating in a simplex printing mode are used on both faces of a plurality of sheets forming a document or book block. The first printer prints an image on a first side or face of a sheet, where a number of sheets are stored in an queue between the first and second printers such that as sheets are printed by the first printer, they are delivered in sequence to the queue, where sheets are fed from the queue to the second printer without the first printer having to delay printing until the second printer is ready for the next sheet, and where the second printer may have a sheet delivered to it without the second printer having to await for the first printer to print a sheet thereby to allow both the first and the second printers to print at substantially their maximum simplex printing speeds.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE DISCLOSURE

In recent years, print on demand (POD) book printing, binding and trimming systems have been developed, such as shown in my U.S. Pat. No. 7,014,182. This last-mentioned patent used one or more conventional black and white duplex laser printers for printing the text pages that constituted the book block of the POD book. Such commercially available duplex printers were relatively expensive, and, because of the complicated paper path needed for duplex printing, the duplex printing speed of such printers was limited to a little more than one-half of their simplex printing speeds (e.g., about 32-37 duplex impressions per minute for a printer capable of about 50 impressions per minute in simplex mode), where an impression involves the printing of text or other indicia on one face of a sheet. Thus, the time for one of these duplex printers to print a typical book block having about 250 pages (i.e., about 125 sheets having text printed on both sides of each of the sheets) was about 8 minutes. Once the time required to print the book block and subsequent binding and trimming operations is factored in, a POD book system as shown in FIG. 13 of my above-noted U.S. Pat. No. 7,014,182 with a single duplex text printer was limited to about 7-10 books/hour. In order to increase the throughput of such POD book manufacturing systems, I developed a system as shown in FIG. 21 of my above-identified patent that used two black and white duplex text printers. While this did increase the throughput of the POD system, it significantly increased the cost of the system and required a relative larger footprint for the system.

Prior sheet fed duplex printers typically had complicated paper paths within the printer that allowed a single print engine to print on both faces of a sheet by first printing on one face of the sheet, then inverting the sheet, then feeding the sheet back through the print engine in reverse direction to print on the other face of the sheet, and finally ejecting the printed sheet. As noted, these complicated paper paths significantly slowed duplex printing operations to about one half the speed of simplex printing of the printer. In addition, the majority of paper jams in such prior art duplex printers occurred in the complicated paper paths of these duplex printers. Reference may be made to such U.S. Patents as U.S. Pat. Nos. 5,150,167 and 6,317,581, which illustrate prior art duplex printing systems employing two print engines with complicated paper paths supplying the print engines.

Further, in duplex printers using two print engines, it has been a problem that if the first print engine is printing a bit mapped image or data rather than a vector based image, in that such bit mapped images typically require longer to print. Thus, if the first print engine is slow to print a bit mapped image, the second print engine is likewise delayed. Similarly, if the second print engine is commanded to print a bit mapped image, the first print engine must be paused to wait for the second print engine to be ready for the next sheet to be printed. These delays have significantly slowed the throughput of such dual print engine duplex printers.

In addition, such existing duplex printing systems employing two print engines are timing sensitive between the two print engines. That is, when one print engine is ready to move its image to the sheet, the sheet must be in a correct position with respect to that print engine. If the sheet is not properly positioned relative to the print engine at the instant the print engine is ready to transfer the image to the sheet, the printer will try for a short time (e.g., 1100 milliseconds) to properly position the sheet. If after this short time the sheet is not properly positioned, the printer may go to an error mode and request operator intervention. Thus, there has been a persistent problem in using two print engines to duplex print. It has been a problem to insure that the second print engine always has a sheet on which to print when it is ready to print the next sheet without having to wait for the first printer to print that sheet and to deliver that next sheet to the second printer. There has also been a problem if the second printer is slow to print its sheet in that the first printer may have to wait for the second printer before the first printer can deliver the next sheet. These problems have significantly slowed the duplex printing operations of such two print engine duplex printers.

### SUMMARY OF THE DISCLOSURE

Apparatus of the present disclosure for printing a book block or other document is disclosed. The book block or other document has a plurality of sheets capable of having text printed on one or both faces thereof. This apparatus comprises a first printer capable of printing text on a first face of each sheet. The apparatus further has a second printer capable of printing print text on a second face of each sheet. An accumulator is provided within a sheet path between the first printer and the second printer. This accumulator accumulates a queue of sheets printed by the first printer, such that the first printer may print subsequent sheets without having to pause while the second printer is printing and such that the second printer may print on a second face of a sheet without having to await delivery of the sheet from the first printer.

A method of duplex printing on both faces of a plurality of sheets forming a multi-sheet book block or other document using a first print engine and a second print engine is disclosed. This method comprises the steps of supplying a plurality of sheets to the first print engine. The first print engine is operated so as to print an image on a first face of a first sheet. This first sheet is conveyed from the first print engine toward the second print engine. The second print engine is operated so as to print images on a plurality of first faces of a plurality of subsequent sheets. The subsequent sheets are conveyed from first print engine toward the second print engine. These sheets are accumulated in a queue of a plurality of sheets printed by the first print engine prior to conveying the sheets to the second print engine where the sheets in the queue are in sequence to be printed by the second printer. A next sheet is withdrawn from the queue and is conveyed to the second print engine where the second print engine prints an image on the second face of such sheet without having to wait for the first print engine to print on such sheet. The sheets printed by the second print engine are accumulated so as to constitute a book block or other document.

The objects and features of this disclosure will be in part described herein and in part apparent to one of ordinary skill in the art in view of the instant disclosure.

### BRIEF DESCRIPTION OF THE DRAWINGS

FIG. 1 is a diagrammatic view of duplex printing apparatus in accordance with this disclosure having a first printer (or print engine), a second printer (or print engine), a supply of paper sheets for the first printer, a paper path for conveying sheets printed by the first printer to the second printer, an accumulator within the paper path for accumulating a queue of sheets such that the first sheet in the accumulator is the next sheet to be fed to the second printer with an adequate number of sheets within the queue such that neither the first nor the second printer must wait for the other printer to print a sheet;

FIG. 2 is an enlarged reverse perspective view of the accumulator illustrating how sheets printed by the first printer are delivered to the queue and how sheets are withdrawn from the queue and delivered to the second printer;

FIG. 3. is an enlarged side elevational view of the accumulator shown in FIG. 2;

FIG. 4 is a diagrammatic view of the paper (sheet) path illustrating the first and second printers and the orientation of the paper as it is fed along the paper path from the first printer to the second printer and illustrating how the text or images are printed on both faces of the sheets by the two printers.

FIG. 5 is a block diagram of the printing apparatus of the present disclosure showing the steps involved in controlling operation of the components of the apparatus and disclosing some of the steps involved in the method of this disclosure;

FIG. 6 is a diagrammatic view of a paper separator for insuring that the next sheet to be fed from the queue is fed from the top of the queue; and

FIG. 7 is a diagrammatic view of another paper separator for insuring that the next sheet to be fed from the queue is fed from the bottom of the queue.

Corresponding reference characters represent corresponding parts through the several views of the drawings.

### DESCRIPTION OF PREFERRED EMBODIMENTS

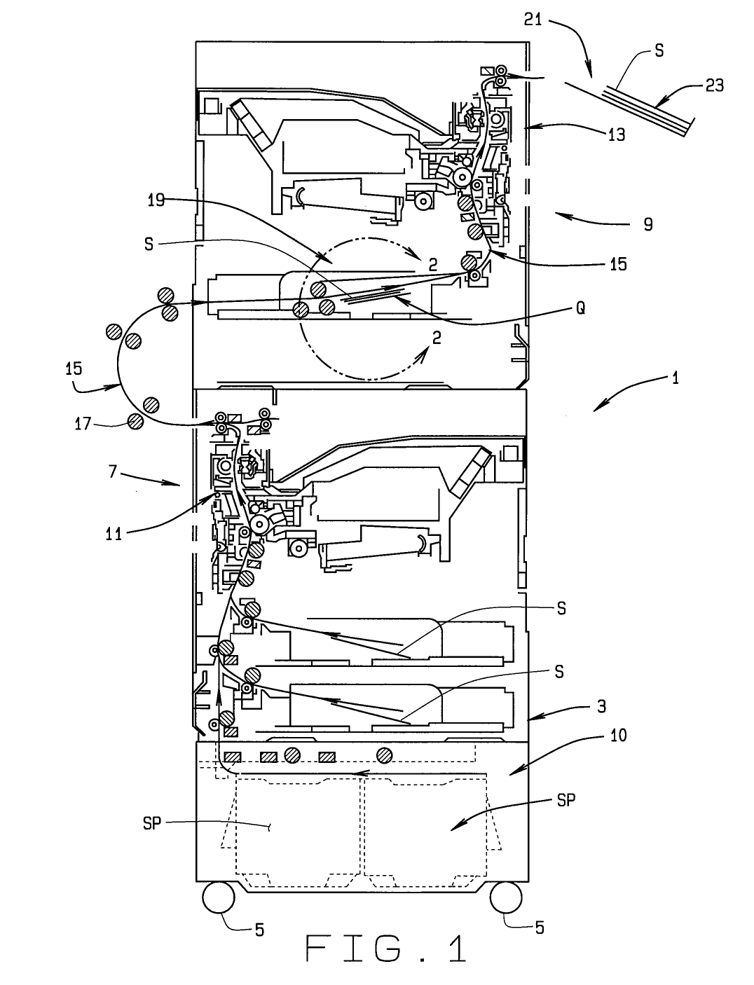

Referring now to FIG. 1 of the drawings, duplex printing apparatus in accordance with the present disclosure is indicated in its entirety at 1. The apparatus 1 has a frame or other structure 3 that supports the apparatus on wheels 5 so that the apparatus may be readily positioned proximate a print on demand book printing, binding and trimming apparatus, as, for example, shown in my U.S. Pat. No. 7,014,182, which is incorporated by reference herein.

More specifically, apparatus 1 includes a first printer, as indicated at in its entirety at 7, and a second printer, as indicated in its entirety at 9. A paper supply 10 holds a supply SP of sheets S (preferably, but not necessarily, paper sheets) and is preferably positioned below the first printer 7 for supplying sheets to the first printer 7 one sheet at time. The first and second printers may be conventional laser duplex printers commercially available from any one of a variety of manufacturers and operable in both a simplex and a duplex printing mode. One such printer that has worked well in this application is Model FS 9530 DN commercially available from Kyocera Mita having a domestic address of United Office Solutions, One Battery Park Plaza, 4^{th} Floor, New York, N.Y. 10004. The paper path from paper supply 10 to the first printer 7 is part of such commercially available printer and does not per se constitute a part of the present disclosure other than to show that there should be a supply SP of sheets S and the sheets must be fed from the supply to the first printer. It will be understood that in the instant application, such commercially available printers are only operated in their simplex printing modes and that the duplex paper paths used within these commercially available printers are not utilized.

As indicated generally at 11, the first printer 7 has an electrographic printing unit or print engine 11 (e.g., a laser print engine) that is capable of printing on one face of sheets S fed through the first printer and the second printer 9 has a similar print engine 13 that is capable of printing on the other face of the sheets fed through the second printer. As the sheets printed by the first printer are ejected from the first printer, each sheet enters a sheet or paper path, as generally indicated at 15, which conveys the sheet from the first printer 7 to the second printer 9. It will be noted that sheet path 15 has a forward-driven path to convey the sheets from the first to the second printer without movement of the sheet in a reverse direction prior to being delivered to the second printer. This, of course, speeds the delivery of sheets to the second printer and is a much simpler path and thus less likely to cause paper jams. As shown, paper or sheet path 15 includes a plurality of power driven rollers 17 that grip the sheet(s) and conveys the sheet(s) along the paper path.

As generally indicated at 19, an accumulator is provided for accumulating a queue Q of sheets S printed by the first printer 7 and for supplying sheets S to the second printer 9. Preferably, but not necessarily, paper path 15 inverts the sheets printed by the first printer 7 prior to a sheet being delivered to the accumulator 19. While not shown in the drawings, it will be understood by those skilled in the art that this inversion of the sheets may be performed after the sheets are withdrawn from accumulator 19 and as they are fed to the second printer.

Sheets S ejected from the second printer 9 are fed into a second sheet accumulator 21 where the sheets form a multi-sheet book block 23 for a book or other document. It will be understood that with the sheets forming book block 23, the book block may then be used to produce a book using the apparatus as described in my U.S. Pat. No. 7,014,182 or other such apparatus. The accumulator 21 may be similar in construction and operation to the book page printer transfer mechanism 112 and/or the collator tray 134 described in my afore-mentioned U.S. Pat. No. 7,014,182, which, as noted, is herein incorporated by reference.

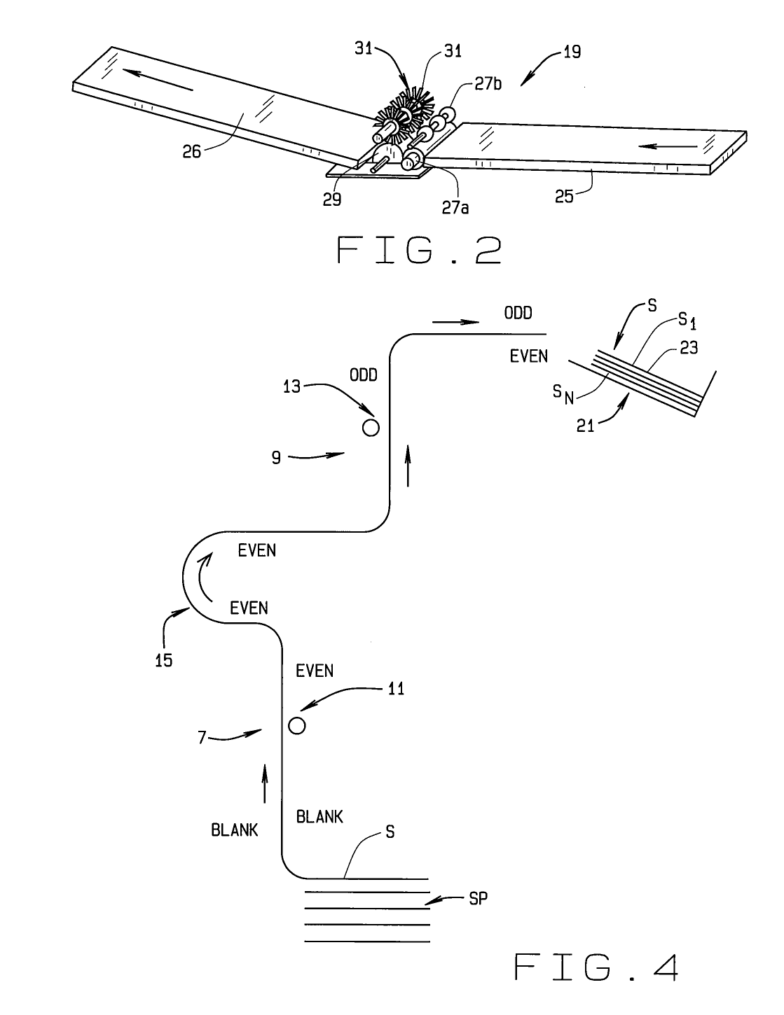

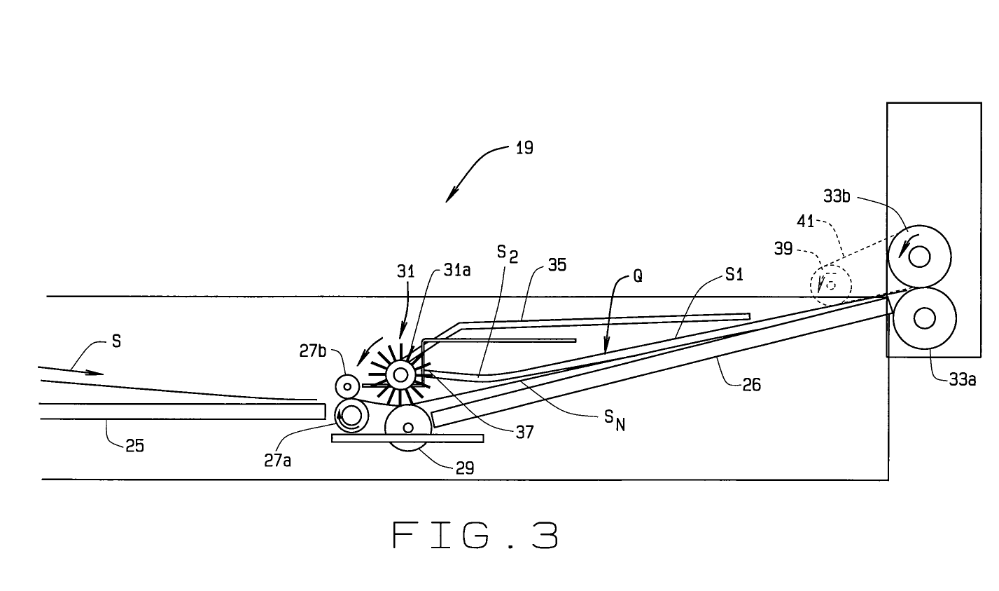

Referring now to FIGS. 2 and 3, accumulator 19 is shown in greater detail where the accumulator is shown to have a sheet delivery tray 25 onto which sheets S printed by the first printer 7 are delivered to the accumulator via paper path 15. A pair of driven rollers 27a, 27b grip the leading edge of each sheet S and position the sheets in the accumulator so as to form sheet queue Q, which is supported on a support tray 26. As noted, queue Q includes a number N of sheets S (i.e., at least one sheet and less than a limited number of sheets). For example, it has been found that if about 2-10 sheets are accumulated in queue Q, that is a sufficient number so as to insure that the second printer 9 need not wait for a sheet printed by the first printer to be delivered to the second printer and so that the first printer may continue to print sheets in the event that the second printer is slow to print its sheet. However, it will be understood that the queue Q may have as few as a single sheet therein and the maximum number of sheets S_{N} in the queue may be significantly more that ten and the advantages of the queue as herein described may still be realized.

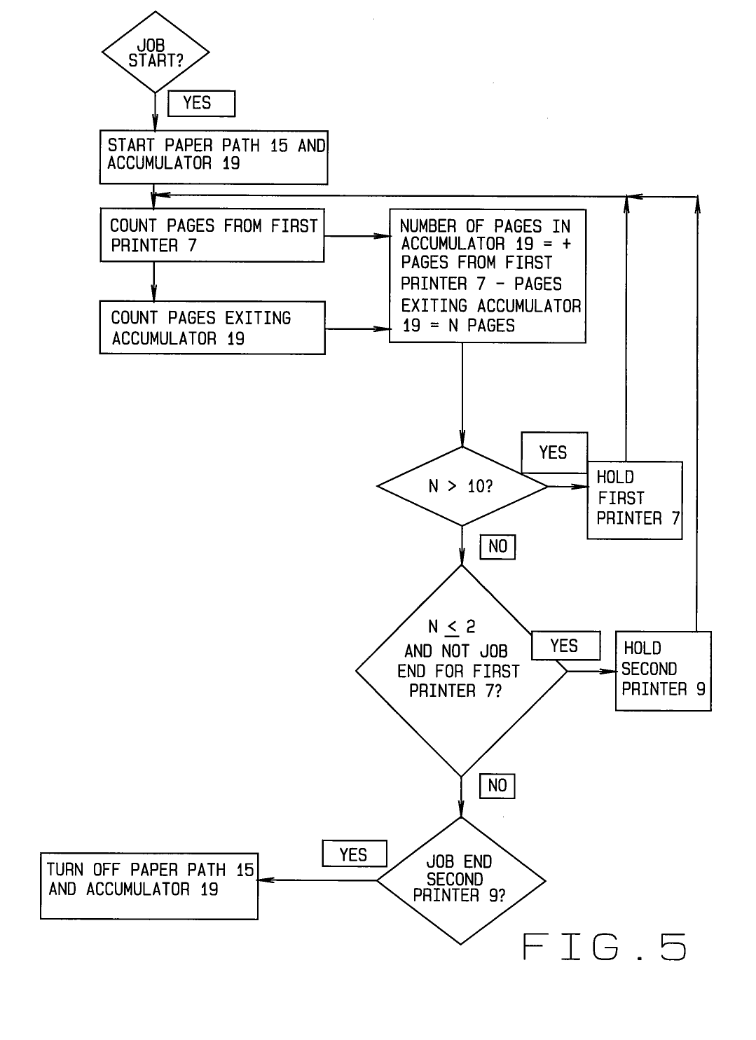

One preferred method of operation of accumulator 19 is depicted in FIG. 5 to be under the control of a computer control systems for printers 7 and 9. In this instance, the computer control systems for the commercially available printers 7 and 9 have been utilized and modified in accordance with the steps of FIG. 5. However, those skilled in the art will recognize that other control systems and strategies may be employed to achieve the desired operation of the accumulator.

As shown in FIG. 3, accumulator 19 further includes one or more lifting non-driven rollers 29 that hold the trailing end of the first delivered sheet S₁ within the queue Q. With the trailing end of the first sheet position on rollers 29, slotted feed rollers 31 are driven in counterclockwise direction (as shown in FIG. 3). These feed rollers have flexible radial fingers 31a that engage the trailing edge of the first sheet S₁ in queue Q so as to lift the trailing edge of the first sheet and so as to bias the first sheet toward a pair of separator rollers 33a, 33b proximate the leading edge of the first sheet. When the second printer 9 is ready to print the next sheet, the separator rollers 33a, 33b are actuated so as to only grip the leading edge of the first sheet S₁ in queue Q and to feed this sheet to printer 9. When the second printer 9 is ready to print the next sheet, separator rollers 33a, 33b are actuated by the printer's internal control system thus drawing the leading edge of the next sheet in the queue (e.g., the top sheet in the queue), while withholding any other sheets in the queue so as to only feed the first sheet S₁ in the queue to printer 9 in addition to serving as separator rollers, rollers 33a, 33b feed the next sheet to be printed to the second printer 9. These separator rollers 33a, 33b and the operation of the accumulator 19 will be described in greater detail hereinafter in regard to FIG. 6.

As subsequent sheets S₂-S_{N} are delivered to the queue Q, the subsequent sheets are disposed below sheet S₁ (as shown in FIG. 3) and below one another in sequence. The trailing edges of the subsequent sheets are also lifted by feed rollers 31. Flexible guide fingers 35 hold the first sheet S₁ in place within queue Q and guide or bias the first sheet S₁ toward separator rollers 33a, 33b. Stops 37 positioned between rollers 31 prevent the trailing edges of the sheets from being pulled rearwardly by rollers 31. Upon the second printer 9 being ready to receive the next sheet S to be printed thereby, a signal is sent by the printers' internal control system(s) so as to initiate operation of rollers 33a, 33b to grip the leading edge of the next sheet and to feed it to the second printer in the manner hereinafter described in greater detail in regard to FIG. 6. The next sheet S₂ in queue Q is held to await a signal from the control system(s) to actuate separator rollers 33a, 33b so as to feed this next sheet to the second printer.

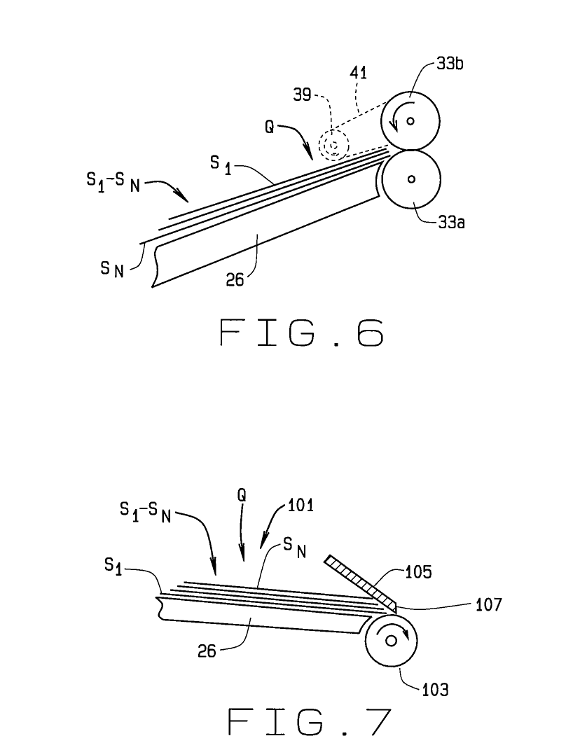

In this manner, the first printer 7 may continue to print sheets and to deliver these subsequent sheets to the bottom of queue Q, and the queue will deliver the next sheet to be printed by the second printer 9 to the second printer without the printers to wait for one another. It will be recognized that accumulator 19 thus operates as a first in, first out (FIFO) accumulator thereby to insure that the sheets are delivered to the second printer in proper timed relation to the second printer thereby to allow the second printer to operate at substantially its maximum simplex printing speed without having to await the delivery of sheets from the first printer in the event that the first printer is slow to print one or more sheets. Further, the first printer 7 may thus be operated at (or near) its maximum simplex printing speed without having to await the second printer 9 to print a sheet because the sheets printed by the first printer are delivered to the queue Q in accumulator 19. By delivering sheets to the second printer from the queue in a first in, first out (FIFO) order, the sheets printed by the second printer are printed in order such that the first printer may print the even numbered pages of a document (or book block) and the second printer may print the odd numbered pages of the document (or book block), or vice versa. While the FIFO queue Q described above has subsequent sheets delivered to the bottom of the queue and has sheets picked from the top of the queue to be delivered to the second printer, those skilled in the art will recognize that the FIFO queue may also have the subsequent sheets delivered to the top of the queue and picked from the bottom of the queue, as shown in FIG. 7.

Referring now to FIG. 5, this block diagram illustrates the main steps for operating the queue Q under the control of the controller(s) for printers 7 and 9, or under the control of only one of such controllers. It will be understood that each of the printers has its own internal controller and that in accordance with the instant disclosure, these controllers have been modified so that both printers work in concert in accordance with the flow diagram of FIG. 5 so as to control operation of the printers and of sheet path 15 and accumulator 19. Alternately, a whole new control system may be utilized as would be apparent to one skilled in the art, but the modified controllers included in such commercially available printers has been found to work well and are thus preferred, but not required.

As shown in the upper left corner of FIG. 5, operation of paper path 15 and accumulator 19 is started. As sheets S are printed by the first (lower) printer 7 and are delivered to accumulator 19, these sheets are counted and the sheets exiting the accumulator 19 and delivered to second printer 9 are counted. This yields the number N of pages in the FIFO queue Q in accumulator 19. If the number N of pages in the queue is greater than, for example, 10, a command is given to the first printer 7 to temporarily halt printing of additional sheets. However, if the number N of pages in the queue is equal to 1 (and preferably 2-4), a signal is generated to temporarily halt the second printer from printing additional sheets so that more sheets may be accumulated in the queue Q. Thus, as long as the number N of sheets in the queue is between about 1 and 10 or more (and preferably between 4 and 10), both the first and second printers will be operated at (or near) their respective maximum simplex printing speeds without one printer having to wait on the other printer to print a sheet. It will be appreciated that the number N of sheets S between 2 and 10 is only a preferable number that has been found to work well because it allows both printers to operate at their maximum simplex printing rate for the vast majority of the time. However, the number N of sheets in the queue Q may be varied considerably from this preferred number so as to insure that both printers are able to operate at their maximum simplex printing speeds. It will be understood that the advantages of the queue Q may be realized in the queue has as few as a single sheet S therein.

As shown in FIG. 4, the flow of a sheet S is shown from sheet (paper) supply SP to the first printer 7, to the second printer 9, and thence to the second accumulator 21 where sheets S printed on both sides (faces) may be accumulated so as to form a document or book block 23. For example, the first printer 7 may print an image or text on an even numbered page of the document (or book block). As the sheet exits the first printer, it is conveyed by paper path 15, which inverts the sheet approximately 180° (i.e., the sheet is flipped over such that the second printer may print on the opposite face of the sheet) prior to delivering the sheet to the second printer 9 so that the sheets are in proper position to have their other faces printed by printer 9. While the paper path 15 is described above as inverting the sheet approximately 180°, those skilled in the art the number of degrees through which the sheet is inverted is not critical so long as the sheet is flipped over so that its opposite face may be printed by the second printer. The second printer 9 then prints an image or text on the opposite face of the sheet (i.e., an odd numbered page) such that when the sheets are ejected from the second printer and stacked in accumulator 21, the sheets have the appropriate text (or are left blank) so as to constitute all of the odd and even numbered pages of the book block (or document 23). In such a printing sequence, the book block is printed in reverse page order. That is, the last page of the book block is printed first, such that as the sheets S are delivered to accumulator 21, the pages of the book block (or other document) 23 are properly collated. However, it will be recognized that by providing other paper paths with simple inverting paths, the book block may be printed beginning with the first page of the book block. As used in this disclosure, the terms “even numbered pages” and “odd numbered pages” merely refer to the opposite faces of the sheets S comprising the document or book block 23 to be printed and do not necessarily mean only the pages that have even and odd page numbers.

Turning now to FIG. 6, one embodiment of separator rollers 33a, 33b is shown that feeds sheets S from the top of queue Q to second printer 9. These separator rollers and their operation are those used in the above-identified commercially available Kyocera printers. This embodiment is similar to that shown in FIG. 3. There, roller 33b is shown to be selectively driven in counterclockwise direction when the roller is actuated under the control of the controller of printer 9 so as to feed the next sheet S₁ in queue Q to the second printer. Roller 33a is held in contact with roller 33b by springs (not shown) and has a rotational drag induced in its rotation enough to overcome “normal” static cling between sheets S₁-S_{N} (preferably paper sheets) in queue Q. Sheets S₁-S_{N} in queue Q slide on the upper surface of tray 26 and are biased forward into the nip of rollers 33a and 33b by fingers 31 and stops 37, as shown in FIG. 3. Sheets S₁-S_{N} in queue Q are thus lifted to the position shown in FIG. 3. Optionally, another roller 39 (as shown in phantom in FIG. 3) may be selectively moved from a raised or retracted position to a lowered position (as shown in FIGS. 3 and 6) in which roller 39 frictionally engages the top sheet S₁ of queue Q. Roller 39 is synchronously driven with roller 33b preferably by a toothed belt 41, as shown in FIG. 3. Thus, roller 39 and roller 33b are rotatably driven so as to feed the sheets S₁-S_{N} into the nip of rollers 33a, 33b. As roller 33b turns, if no sheet is between roller 33b and roller 33a, roller 33a also turns by its friction with roller 33b, dragging any single sheet in contact with roller 33a into the nip between the rollers 33a, 33b. However, if more than one sheet is present, that is, sheets S₁-S_{N}>1, multiple sheets enter the nip of rollers 33a 33b, roller 33a is moved away from driving roller 33b causing roller 33a to cease turning because of the loss of the friction between the two rollers due to the rotational drag mentioned above. Roller 33a now becomes a stop for those sheets in contact with roller 33a. Roller 33b continuing to rotate, draws sheet S₁ on the top of queue Q further into the nip of the rollers 33a, 33b. However, since stop roller 33a is no longer turning, the stop roller now functions as a stationary stop allowing only the topmost sheet S₁ to continue to be fed toward second printer 9. When there is only one sheet S remaining in the queue, the axial drag of stop roller 33a is overcome and again begins to turn and roller 33b feeds the single sheet toward the second printer.

Referring now to FIG. 7, an alternate embodiment of a system for feeding a single sheet S₁ to the second printer 9 is shown in its entirety at 101. It will be particularly noted that system 101 differs from the system shown in FIGS. 3 and 6 in that those systems feed sheets from the top of queue Q, while the system of FIG. 7 feeds sheets from the bottom of the queue. In FIG. 7, sheets S₁-S_{N} in queue Q are shown to be supported on support tray 26. A roller 103 is driven in clockwise direction, as shown in FIG. 7. A stop 105 is positioned at an angle, approximately as shown in FIG. 7, so that its bottom angled edge 107 comes within the thickness of one sheet S so as to only allow a single sheet (the bottommost sheet) to contact roller 103. Roller 103 and stop 105 are similar to rollers and stops employed in commercially available scanners, such as Model M3093DG from Fujitsu America, Inc., 1250 East Arques Avenue, Sunnyvale, Calif. 94085.

As further shown in FIG. 7, sheets S₁-S_{N} in queue Q are supported on tray 26 surface such that the first sheet S₁ is on the bottom and such that the last sheet in the queue S_{N} is on top. Thus, in turn, as a sheet is fed off the bottom of queue Q, each sheet in the queue in turn contacts stop 105. As roller 103 is selectively rotated under the control of the controller of printer 9, sheets S₁-S_{N} in queue Q are fed from the bottom of the queue beginning with sheet S₁ due to the angularity of stop 105 and its close position to roller 103. As the bottom sheet S1 is fed to the second printer, the remaining sheets S₂-S_{N} in the queue Q, are held in the queue and are not fed to the second printer with sheet S₁.

In the printing of a book block 23 having “M” pages, where “M” is the last page of the book block, and where “M/2” is the number of sheets in the book block and where “M/2” is a whole number, the first printer 7 prints the next to the last page “M−1” of the book block on a first face of a first sheet, and the second printer 9 prints the last page “M” of the book block on a second face of the first sheet. Then, the first printer prints page “M −3” on a first face of the second sheet to be printed, and wherein the second printer prints page “M −2” on the second face of the second sheet, such that when the first and second printers continue to operate in such fashion until the first printer prints page “M−(M-1)”, which is the first page of the book block of a first face of sheet “N/2” and the second printer prints page “M−(M-2)” of a second face of sheet “M/2”. In this manner all of the pages for the book block 23 may be printed such that when the sheets are collated in accumulator 21, the pages for the book block are properly collated.

As used in this disclosure the terms in the following claims have their plain and ordinary meaning to those of ordinary skill in the art within the context of this disclosure. In addition, but not in a limiting sense, the following terms will also be understood by those skilled in the art to not only to have their plain and ordinary meanings, but also to have the meanings as hereinafter described. A “duplex printer” is a printer that is capable of printing on one or on both sides (or faces) of a sheet, usually, but necessarily, a paper sheet. A “simplex printer” is a printer that is capable of printing only on one side of a sheet, usually, but not necessarily, a sheet of paper. A “sheet” is preferably a broad flat piece of limp material such paper, plastic film, cloth or the like that is preferably precut to a rectangular, other polygonal, or curvilinear shape. The term “text” as used in this disclosure is the content, image pattern, or other indicia printed on a page of the document and it may include, but is not limited to, words, photographs, graphics, charts and any other materials or indicia that may be contained in a book or other document. The “text pages” of a book include all pages of the book except the cover and such text pages may include blank pages. An “image” or “image pattern” includes text (as described above) and other indicia that may be printed on a page. A “book” includes a plurality of text pages comprising a book block and a cover. A “book block” is a document having plurality of sheets having text printed on the faces of the sheets, but there may be blank pages in the book block. The book block is typical of rectangular form, but it may assume other polygonal or curvilinear shapes. A book block typically has one edge thereof (typically along a major rectangular dimension) that constitutes the spine of the book block. The “cover” of the book may be of a sheet of heavier stock than the text pages that is wrapped around and adhesively secured to the spine of a book block, or it may be the cover of a hard cover book bound to the book block in the conventional manner. The term “invert” is used in its plain and ordinary manner and among other meanings will be understood to mean to put a sheet upside down or in the opposite position, order, or arrangement relative to an earlier orientation.

A “high speed printer” as used in this disclosure means that the printing apparatus of the present disclosure may print in a duplex mode at or near to each of the printers 7 and 9 simplex printing speeds. By way of example, if the simplex printing speed of each of the printers 7 and 9 used in the present disclosure is about 50 sheets (pages)/minute, the printing apparatus 1 of the present disclosure may be capable of printing images on both faces of such 50 sheets so as to print 100 pages/minute.

It will be understood, however, that ink jet and electron beam printers may also be used in accordance with this disclosure. The term “queue” as used in this disclosure shall be understood by those skilled in the art to have its plain and ordinary meaning and shall also mean a sequence of sheets S awaiting their turn to be printed by the second printer 9.

As various changes could be made in the above constructions without departing from the broad scope of the invention, it is intended that all matter contained in the above description or shown in the accompanying drawings shall be interpreted as illustrative and not in a limiting sense.

1. Apparatus for printing a book block or other document, said book block or other document having a plurality of sheets capable of having text printed on one or both faces thereof, said apparatus comprising:
a first printer capable of printing text on a first face of a each sheet;
a second printer capable of printing print text on a second face of each sheet;
an accumulator, in a sheet path between said first printer and said second printer, to accumulate a queue of sheets printed by said first printer, such that said first printer prints subsequent sheets without having to pause while said second printer is printing and said second printer prints on a second face of a sheet without having to await delivery of said sheet from said first printer.

2. Apparatus as set forth in claim 1, further comprising:
a supply of said sheets for said first printer; and
a sheet pickup to pickup a first sheet in said queue and to feed said first sheet to said second printer such that said second printer prints on a second face of said first sheet and such that a second sheet in said queue becomes the next sheet to be picked up by said sheet pickup and fed into said second printer, while said subsequent sheets printed by said first printer are delivered to said queue in sequence such that both printers operate substantially at their optimum simplex printing speeds without said need for said first printer to pause while said second printer is printing and said need for said second printer to await delivery of said second sheet from said first printer.

3. Apparatus as set forth in claim 2, wherein said sheet pickup only picks said first sheet in said queue such that said accumulator delivers sheets to said second printer on a first in, first out basis.

4. Apparatus as set forth in claim 3, wherein sheets are delivered to bottom of said queue and are picked from the top of said queue to be delivered to said second printer.

5. Apparatus as set forth in claim 3, wherein sheets are delivered to the top of said queue and are picked from the bottom of said queue to be delivered to said second printer.

6. Apparatus as set forth in claim 1, wherein said queue comprises a first sheet printed by said first printer and an N^{th} sheet printed by said first printer, where N represents a number of sheets to be accumulated in said queue and is greater than or equal to one.

7. Apparatus as set forth in claim 6, wherein said number N of sheets accumulated in said accumulator may vary over the time that said apparatus is operated to print said book block.

8. Apparatus as set forth in claim 1, wherein said sheet path comprises a forward-direction path to convey said sheet between said first printer and said second printer without movement of said sheet in a reverse direction prior to said second printer printing on said second face of said sheet.

10. Apparatus as set forth in claim 1, wherein said sheet path turns over each said sheet printed by said first printer as it is conveyed from said first printer to said second printer so that the second printer may print on the opposite face of the sheet.

11. Apparatus as set forth in claim 10, wherein said sheet path turns each said sheet prior to such sheets being accumulated in said queue.

12. Apparatus for printing a book block of a book or other document of a plurality of sheets capable of having text printed on one or both faces of said such sheets in a print-on-demand book printing system, said apparatus comprising:
a first printer to print text on a first face of each sheet;
a second printer to print text on a second face of each sheet;
an accumulator, in a paper path between said first printer and said second printer, to receive sheets printed by said first printer and to accumulate a queue of said sheets; and
a paper pickup to pickup a last-fed sheet in said queue and feed said last-fed sheet to said second printer such that a sheet in said queue prior to said last-fed sheet becomes the next sheet to be picked up by said sheet pickup.

13. Apparatus as set forth in claim 12, wherein said queue comprises a first sheet printed by said first printer and an N^{th} sheet printed by said first printer, where N represents a number of sheets to be accumulated in said queue and is greater than or equal to one.

14. Apparatus as set forth in claim 12, further wherein said paper path turns each said sheet printed by said first printer approximately 180° as it is conveyed from said first printer to said accumulator.

15. Apparatus as set forth in claim 12, wherein said last-fed sheet in said queue is on the top of said queue such that sheets removed from said queue to be fed to said second printer are removed from the top of said queue and sheets already delivered to said queue are on the bottom of said queue.

16. Apparatus as set forth in claim 1 or 12, wherein said second printer ejects sheets printed thereby into a second accumulator which accumulates said sheets printed by said first and second printers into said book block or other document.

18. Apparatus as set forth in claim 6 or 13, wherein “M” is the number of pages in said book block and page “M” is the last page of said book block, wherein “M/2” is the number of sheets in said book block and “M/2” is a whole number, wherein said first printer prints the next to the last page “M-1” on a first face of a first sheet, and wherein said second printer prints the last page “M” on a second face of said first sheet, and wherein said first printer prints page “M-3” on a first face of said second sheet to be printed, and wherein said second printer prints page “M-2” on said second face of said second sheet, wherein said first and second printers are operated in such fashion until said first printer prints page “M-(M-1)” which is the first page of said book block of a first face of sheet “N/2” and said second printer prints page “M-(M-2)” of a second face of sheet “M/2”.

19. A method of duplex printing on both faces of a plurality of sheets forming a document using a first print engine and a second print engine, said method comprising the steps of:
a. Supplying a plurality of sheets to said first print engine;
b. Operating said first print engine so as to print an image on a first face of a first sheet;
c. Conveying said first sheet from said first print engine toward said second print engine:
d. Operating said first print engine so as to print images on a plurality of first faces of a plurality of subsequent sheets;
e. Conveying said subsequent sheets from first print engine toward said second print engine;
f. Accumulating a queue of a plurality of sheets printed by said first print engine prior to conveying said sheets to said second print engine where the sheets in said queue are in sequence to be printed by said second printer;
g. Withdrawing a next sheet from said queue and conveying it to said second print engine where said second print engine prints an image on said second face of such sheet without having to wait for said first print engine to print on such sheet; and
h. Accumulating said sheets printed by said second print engine so as to constitute a document or book block.

20. The method of claim 19, further comprising the step of inverting said sheets printed by said first print engine prior to said sheets being delivered to said second print engine so that said second print engine may print of the second face of such sheets.

21. The method of claim 19, wherein said sheets are inverted prior to said sheets being accumulated in said queue.

22. The method of claim 19, further comprising withdrawing sheets from said queue and delivering said sheets to said second print engine on a first in, first out basis.

23. The method of claim 22, wherein one of said print engines prints the even numbered pages of said document and wherein the other of said print engines prints the odd numbered pages of said document.

24. The method of claim 19, wherein the step of accumulating a number of sheets in said queue involves accumulating a sufficient number of sheets in said queue so as to insure that said second print engine has a sheet to print when said second printer is ready to print its next sheet in the event that said first print engine is slow to deliver a sheet to said queue.

25. The method of claim 20, where said first printer may continue to print sheets and deliver such sheets to said queue without having to await said second printer to first print a sheet from said queue.
